(19) United States
(12) Patent Application Publication
(10) Pub. No.: US 2010/0296902 A1
(43) Pub. Date: Nov. 25, 2010

(54) APPARATUS FOR LOADING AND UNLOADING LOADING UNITS

(75) Inventors: Carsten Aschpurwis, Konstanz (DE); Andrea Scagliola, Ammerthal (DE); Wolf-Stephan Wilke, Konstanz (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munchen (DE)

(21) Appl. No.: 12/787,016

(22) Filed: May 25, 2010

(30) Foreign Application Priority Data
May 25, 2009 (DE) 10 2009 022 527.7

(51) Int. Cl. B60P 1/64; B65G 67/02

(52) U.S. Cl. 414/499

(57) ABSTRACT

An apparatus for loading and unloading loading units with stackable articles, in particular interchangeable load carriers, such as swap bodies or similar transport devices which can be separated from carrier vehicles. In order to make it possible for the stackable articles which are to be transported in loading units to be loaded and unloaded quickly in an ergonomically favorable manner, there is provided a pallet which is fixedly assigned to the loading unit and has a fixed rear supporting wall directed away from the loading side. The rear wall stands upright transversely to the longitudinal extent of the loading unit and is intended for the stack formed on the pallet. It is possible for the latter to be moved longitudinally, at least in part, into the loading unit and out of the loading unit and to be loaded and unloaded outside the loading unit.

### CROSS-REFERENCE TO RELATED APPLICATION

This application claims the priority, under 35 U.S.C. §119, of German patent application DE 10 2009 022 527.7, filed May 25, 2009; the prior application is herewith incorporated by reference in its entirety.

### BACKGROUND OF THE INVENTION

### Field of the Invention

The invention relates to an apparatus for loading and unloading loading units with stackable articles, in particular interchangeable load carriers, such as swap bodies or similar transporting means which can be separated from carrier vehicles.

Parcel couriers (such as, for example, DHL®) transport the parcels from one depot to another in swap bodies or similar loading units. It is advantageous here, in respect of the degree of filling of the loading units, for the parcels to be directly stacked, and also destacked again, in a loose state. The parcels are usually fed and led away via telescopic belts which are retracted into the swap body and at the end of which is stationed typically one individual for stacking and destacking the parcels. The relatively confined amount of space in the swap body means that there is barely any room for more than one worker; this and also the unergonomical working conditions mean that the loading and unloading capacities which can be achieved are extremely limited.

### SUMMARY OF THE INVENTION

It is accordingly an object of the invention to provide a device for loading and unloading load units which overcomes the above-mentioned disadvantages of the heretofore-known devices and methods of this general type and which provides for an apparatus which is intended for loading and unloading loading units, in particular swap bodies, and makes it possible for stackable articles that are to be transported in loading units to be loaded and unloaded quickly in an ergonomically favorable manner.

With the foregoing and other objects in view there is provided, in accordance with the invention, an apparatus for loading and unloading loading units with stackable articles, in particular for loading and unloading interchangeable load carriers such as swap bodies or similar transporting means that can be separated from carrier vehicles. The apparatus comprises:

a pallet permanently assigned to the loading unit, the pallet having a fixed rear supporting wall directed away from a loading side of the pallet, the rear supporting wall standing upright transversely to a longitudinal extent of the loading unit and forming a backing support for a stack of articles on the pallet;

the pallet being movably disposed in a longitudinal direction into the loading unit and, at least in part, out of the loading unit for allowing the pallet to be loaded and unloaded (from) outside the loading unit.

In other words, the objects are achieved with the invention, where there is provided a pallet which is fixedly assigned to the loading unit and has a fixed rear supporting wall that is directed away from the loading side, stands upright transversely to the longitudinal extent of the loading unit and is intended for the stack formed on the pallet, it being possible for the latter to be moved longitudinally, at least in part, into the loading unit and out of the loading unit and to be loaded and unloaded outside the loading unit.

The primary concept of the solution according to the invention is formed by the pallet, which is fixedly assigned to the loading unit and, for ergonomic loading, can be moved out of the loading unit or can be moved forward at least to the extent where it is possible for loading to take place outside the loading unit. Stack formation can thus take place outside the confined space of the loading unit, and this makes it possible to use two or more workers for stacking the articles. As a result, the manual loading and unloading of the loading unit is quicker than at present by at least a factor of two.

According to the invention, the pallet can be displaced on a rail track or roller track within, and possibly directly in front of, the loading unit. If an empty loading unit is to be loaded, then the pallet, in the first instance, is drawn all the way forward into the loading opening. This means that the workers responsible for loading are then working outside, rather than within, the loading unit. Incoming articles for loading are stacked loosely onto the pallet against the rear wall. Once the free part of the pallet has been loaded with a stack row, then the pallet is moved a little way into the loading unit, and this therefore creates, once again, a new free surface in the working areas for further loading.

It is preferably possible to walk on the pallet. However, according to another favorable feature of the invention, it is possible for part of the pallet which projects out of the loading unit to be concealed, at least in part, underground. This can be realized in a false floor into which part of the pallet is pushed, in which case only that part of the pallet which is provided for loading purposes is free.

According to a special feature of the invention, it is provided that the pallet comprises a rigid, short part, which carries the rear supporting wall, and an adjoining flexible part which, with the pallet retracted into the loading unit, extends as far as the loading opening of the loading unit, covering the floor of the latter in the process, and, as the pallet is extended, can be drawn out of the loading unit with the pallet and can be rolled up or folded in, if appropriate, outside the loading unit. According to the invention, the flexible part of the pallet can be reinforced by steel cables.

The pallet of the invention thus comprises a short horizontal piece with is rigid and stiff and carries the rear supporting wall; the remainder, from this rigid part as far as the opening of the loading unit, comprises a flexible carrier which is drawn out and, for example, wound up in order for the pallet to be unloaded. This can take place, for example, in front of the working areas or behind the same. It is also possible, however, for the flexible part to be drawn out straight simply by, for example, steel cables. The articles located on the flexible carrier are removed in the unloading zone in front of the loading unit.

According to the invention, during loading, i.e. as the stack is formed, the pallet can be drawn gradually into the loading unit via a mechanism in accordance with the loading progress and, for the purpose of unloading the stacked articles, the pallet can be drawn gradually out of the loading unit via this or some other mechanism. The mechanism for displacing the pallet, which operates advantageously via deflecting means, is arranged on the loading unit or on the door of the loading location.

In order that the stack, which is supported against the rear wall, does not collapse, the invention provides, on both sides of the loading opening of the loading unit, guides and/or vertically circulating guide belts which support the stack laterally during loading of the pallet. The incoming articles, for example parcels, are stacked loosely onto the pallet against the rear wall and the two lateral guide belts. Once the free part of the pallet has been loaded, then the pallet is moved a little way into the loading unit, and this therefore creates, once again, a new free surface in the working areas for further loading. The lateral guide belts are also set in motion here, and the already formed stack of parcels therefore remains in a stable position. This cycle is repeated until the loading unit has been loaded.

The invention provides that the articles provided for loading and unloading can be fed to the pallet, and led away therefrom, via a conveying means. For loading purposes, the articles come from the sorter for example via a chute and the workers stack them loosely onto the pallet against the rear wall and the two lateral guide belts. For unloading purposes, the pallet, in the first instance, is extended a little way out, and therefore the stacked articles are still retained by the lateral guide belts, these being moved along during the extending movement. The workers remove the front stack and position the articles, for example, on a conveying belt, which leads the articles away. The pallet is then extended out again a little further. The already empty part of the pallet, in turn, can disappear, or be rolled up, beneath the floor. This cycle is repeated until the loading unit has been emptied.

The invention is particularly advantageous because the arrangement allows at least two workers to work ergonomically in a sufficient amount of space. The manual loading and unloading of the loading unit is thus considerably quicker than at present. Since the pallet remains on the loading unit, there is no additional circulating-means circuit. The solution is thus very straightforward and cost-effective. Only a very small amount of space is required, especially since parts of the pallet can disappear beneath the floor at the loading location. There is no longer any need for any telescopic feeding or removal means, and the working area is stationary. The associated sorter end point at the loading location may be of very cost-effective configuration; all that is required is, for example, a large-width box-type chute. In addition, it is also possible for the loading unit with the empty pallet to be used elsewhere, with the volume being utilized virtually to the full extent.

The concept is fully transferable to conventional loading units and the present loading and unloading means with telescopic conveyers.

Other features which are considered as characteristic for the invention are set forth in the appended claims.

Although the invention is illustrated and described herein as being embodied in an apparatus for loading and unloading loading units, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments—here the loading and unloading of a swap body—when read in connection with the accompanying drawings.

### BRIEF DESCRIPTION OF THE SEVERAL VIEWS OF THE DRAWING

FIG. 1 is a plan view of a loading unit in the form of a swap body during the loading operation;

FIG. 2 is a side view of a pallet, with rear supporting wall, that is to be loaded;

FIG. 3 is a plan view of the swap body during the unloading operation; and

FIG. 4 is a schematic side view of a swap body with a partially flexible pallet.

### DETAILED DESCRIPTION OF THE INVENTION

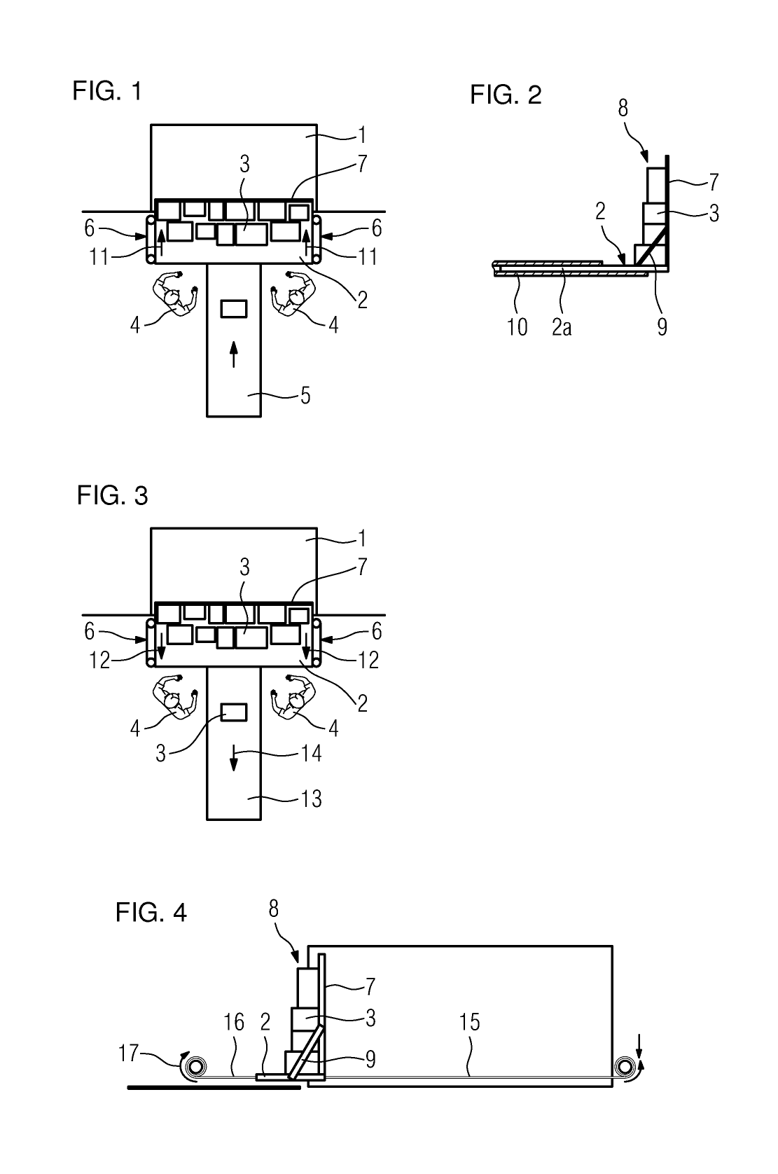

Referring now to the figures of the drawing in detail and first, particularly, to FIG. 1 thereof, there is shown roughly schematic illustration of a plan view of a loading unit 1 which, in the exemplary embodiment, is a swap body. The term swap body is intended to mean interchangeable load carriers that can be separated from a carrier vehicle and, at the same time, are suitable for use in combined rail/road traffic. Such swap bodies are similar to ISO containers; however, in contrast to the latter, they are not of standard dimensions.

The swap body 1 is fixedly assigned a pallet 2 on which the stackable articles, in the example parcels 3, can be stacked in a number of rows one beside the other and in a number of layers one above the other. In the illustration, the pallet 2 has been drawn all the way out of the swap body 1, for example via a rail system, and therefore the two workers 4 have access to the stack of articles 3 on the pallet 2 from both sides of the feed belt 5, which in this case is intended to be a chute. Guide belts 6 are indicated to the sides of the pallet 2, these guide belts extending perpendicularly to the pallet 2 over the entire height of the stack and ensuring that the stack rows so formed do not collapse. A fixed supporting wall 7 is fitted on the rear side of the pallet 2, that is to say the side which is directed toward the swap body 1, and this supporting wall prevents the stack from falling over in the rearward direction. The rear wall 7 extends over the entire height of the stack which is to be formed.

FIG. 2 shows a likewise roughly schematic illustration of a pallet 2 on which a stack row 8 of articles 3 has been formed in four layers. The stack row 8 is supported at the rear by the supporting wall 7, and the supporting wall 7 is fixed to the horizontal pallet 2 via a cross-strut 9, and this therefore creates the necessary stability. The part 2a of the pallet 2, this part projecting out of the swap body 1, has been pushed, in the example of FIG. 2, into a false floor 10 of the loading location, and it is therefore readily possible to walk on the pallet 2 without the displaceable part 2a of the pallet 2 disturbing the workers 4. As soon as the stack row 8, as illustrated in FIG. 2, has been completed, the pallet 2 with its supporting wall 7 is moved in the direction of the arrow 11 into the swap body 1, and therefore a new stack can be formed on the freed space of the pallet 2. Lateral support is always provided here by the guide belts 6 (see FIG. 1), which are set in circulating motion when the pallet 2 is moved in the direction of the swap body 1, and therefore have no relative speed in relation to the stack row 8. The guide belts 6 may be arranged on both sides of the door (not illustrated) to the loading location; in addition, it is also possible to provide guide plates at the transition between the swap body 1 and the lateral guide belts 6 in order to support the stack.

During the unloading operation, which is illustrated schematically in FIG. 3, the pallet 2 is first drawn a little way out in the direction of the arrow 12, and therefore the parcels 3 resting on it are still retained by the lateral guide belts 6. The workers 4, however, work outside the swap body 1, in which case the workers 4 have good access to the stack 8 of parcels 3. The workers 4, then, remove some of the parcels 3 and position them on a conveying belt 13, which leads the parcels away in the direction of the arrow 14. Once an entire stack row 8 has been removed, the pallet is extended out a little farther in the direction of the arrow 12, it being possible for the emptied part of the pallet 2 once again to disappear beneath the false floor (10 in FIG. 2). This cycle is repeated until the swap body 1 has been emptied.

FIG. 4 illustrates a variant in which the pallet 2 is formed from a horizontal rigid part which has a supporting wall 7 fastened on it and which is adjoined by a flexible part. The latter comprises a band 16 which is possibly reinforced by steel cables and can be rolled up 17 or folded together outside the swap body 1, that is to say in the loading and unloading regions. Once a number of stack rows 8 have been formed, the band 16 is likewise loaded, and it is unrolled as the pallet is retracted into the swap body 1. This allows a number of stack rows 8 to be moved into the swap body 1 without the workers 4 having to enter the swap body 1, this only being the case in that stack row 8 upon stack row 8 is formed outside the swap body 1 and is drawn into the swap body 1 together with the fixed part 2 and flexible part 16 of the pallet. Mechanical aids are provided for this purpose, one of these mechanical aids being illustrated here as a traction cable 15 which is fastened on the pallet 2 and continues possibly into the flexible part, the band 16, of the pallet 2. It is conceivable to have other mechanical devices in the region of the door or the loading location, but these do not form a part of the invention.

1. An apparatus for loading and unloading a loading unit with stackable articles, the apparatus comprising:
a pallet permanently assigned to the loading unit, said pallet having a fixed rear supporting wall directed away from a loading side of said pallet, said rear supporting wall standing upright transversely to a longitudinal extent of the loading unit and forming a backing support for a stack of articles on said pallet;
said pallet being movably disposed in a longitudinal direction into the loading unit and, at least in part, out of the loading unit for allowing said pallet to be loaded and unloaded outside the loading unit.

2. The apparatus according to claim 1, wherein the loading unit is an interchangeable load carrier.

3. The apparatus according to claim 2, wherein the loading unit is a transporting means that can be separated from carrier vehicles.

4. The apparatus according to claim 3, wherein the transporting units are swap bodies.

5. The apparatus according to claim 1, wherein said pallet is configured to be displaced on a rail track or a roller track within the loading unit.

6. The apparatus according to claim 5, wherein said pallet is configured to also be displaced directly in front of the loading unit.

7. The apparatus according to claim 1, wherein said pallet is configured to be walked upon.

8. The apparatus according to claim 1, wherein a portion of said pallet projecting out of the loading unit is concealed.

9. The apparatus according to claim 8, wherein said portion of said pallet projecting out of the loading unit is concealed below a floor.

10. The apparatus according to claim 1, wherein said pallet comprises a rigid, short part carrying said rear supporting wall, and an adjoining flexible part which, with said pallet retracted into the loading unit, extends as far as a loading opening of the loading unit, covering a floor of the loading unit in the process, and, as said pallet is extended, can be drawn out of the loading unit with said pallet.

11. The apparatus according to claim 10, wherein said flexible part is configured to be rolled up or folded in outside the loading unit.

12. The apparatus according to claim 10, wherein said flexible part of said pallet comprises steel cables for pulling said pallet.

13. The apparatus according to claim 1, wherein, as the stack is being formed, said pallet is drawn gradually into the loading unit via a mechanism in accordance with the loading progress and, for unloading the stacked articles, the pallet is drawn gradually out of the loading unit by way of a, or said, mechanism.

14. The apparatus according to claim 13, wherein said mechanism for displacing said pallet is disposed via deflecting means on the loading unit or on a door of a loading location.

15. The apparatus according to claim 1, which further comprises guides on both sides of a loading opening of the loading unit, for laterally supporting the stacks during loading of said pallet.

16. The apparatus according to claim 1, which further comprises vertically circulating guide belts on both sides of a loading opening of the loading unit, for laterally supporting the stacks during loading of said pallet.

17. The apparatus according to claim 1, which comprises a conveying device for transporting the articles for loading and for transporting the articles away after unloading.
